(19) United States
(12) Patent Application Publication
(10) Pub. No.: US 2015/0138926 A1
(43) Pub. Date: May 21, 2015

(54) Digital Color Clock

(71) Applicant: Adam C. Roman, Homewood, IL (US)

(72) Inventor: Adam C. Roman, Homewood, IL (US)

(21) Appl. No.: 14/083,119

(22) Filed: Nov. 18, 2013

(51) Int. Cl. G04G 9/04

(52) U.S. Cl. CPC G04G 9/045
USPC 368/11; 368/83

(57) ABSTRACT

A digital color clock uses Color Digits instead of Roman or Arabic numerals. Each Color Digit is capable of displaying a unique color corresponding to one of the ten Arabic numerals (0-9). Preferably the clock contains at least six Color Digits grouped into three pairs. One of the pairs corresponds to hours, another of the pairs corresponds to minutes, and the remaining of the pairs corresponds to seconds. The three pairs can be separated by unit separators. Both the unit separators and the Color Digits can be illuminated using red/green/blue light-emitting diodes. In one embodiment, the Color Digits are interspersed among other unchangeable color panels. In another embodiment, the digital clock senses and displays the temperature, humidity, and/or date using Color Digits.

### FIELD OF THE INVENTION

The present invention relates to the use of color to represent numerical digits in applications involving dynamic digital displays. One embodiment involves use of such color representations in a digital clock with a panel displaying 6 red/green/blue (RGB) light emitting diodes (LED's) that each display a unique color corresponding to, in the embodiment of a clock, each digit of hours, minutes and seconds or in other embodiments, any other dynamic numeric information.

### BACKGROUND OF THE INVENTION

Man has been using devices to keep time from at least as early as the 16^{th} century B.C. These earliest devices were simple water clocks with the first mechanical clocks showing up in 13^{th} century Europe. The first mechanical clocks did not have a visual indicator of the time, but instead signaled the time audibly via bells. Over the centuries, a visual indicator was added in the form of clock face, which eventually evolved into the traditional 12 hour face used on many analog clocks. With advancements in technology, digital clocks that displayed the time in readable digits became prevalent in the 1960s and have steadily been replacing analog clocks. In fact, most individuals today are familiar with digital clocks, and many find them much easier to use than analog clocks.

Common among most clocks, either digital or analog, is their reliance on either Roman or Arabic numbers to indicate the time. Some clocks, such as the one described in U.S. Pat. No. 5,228,013, have abandoned the use of Roman or Arabic numbers. These clocks instead use a complex pattern of flashing lights integrated in a piece of art. While this design is creative, it is not easily identifiable to an uninitiated observer as a clock. Furthermore, even if an individual is aware that the device is a clock and is trained to use it, he must still wait for the clock to go through its complex pattern of flashing lights, to figure out the time. A clock that does not use Roman and Arabic numbers, but still displays the time in a customary format, would be desirable to provide entertainment along with a useful display of the time of day. One such customary format is the one commonly used with digital clocks, namely, [h₁h₂]:[m₁m₂].[s₁s₂], where:

h₁ is the tens digits of the hour being displayed, in units of 0 through 2;

h₂ is the ones digits of the hour being displayed, in units of 0 through 9;

m₁ is the tens digits of the minutes being displayed, in units of 0 through 9;

m₂ is the ones digits of the minutes being displayed, in units of 0 through 9;

s₁ is the tens digits of the seconds being displayed, in units of 0 through 9; and

s₂ is the ones digits of the seconds being displayed, in units of 0 through 9.

### SUMMARY OF THE INVENTION

In one embodiment, the present digital color clock contains a sequence of Light Color Outputs that can display multiple colors depending on the inputs to the LED's through the circuit hardware and firmware that controls the LED sequence for all LED's. In one example, the circuit hardware and firmware controls the LED output colors in a six sequential LED display including a time of day made visible in hours, minutes, and seconds. Time can be displayed in 12 hour or 24 hour outputs. Optional outputs and applications include but are not limited to temporal information such as year, month, day, temperature and humidity.

Instead of the traditional format of displaying standard numerals on a 7-segment or graphic dot-matrix display (or digital representation of a standard analog clock), the present clock has a panel which displays its digits as individual blocks, patches or windows of specific colors (Color Digits). Each color displayed represents, in accordance with a standard or custom “color code”, the specific numbers of the hour, minutes and seconds of the current clock time. Upon learning the color code, a user can tell time using the Color Digits. The Color Digits need not be any specific size or shape, though specific tailoring can be of some advantage to visibility across a distance. Nor need the Color Digits be the same size or shape of each other. For example, the Color Digits representing the hours and minutes could be large circles, while the Color Digits representing the seconds could be small squares.

In one example, the clock uses six Color Digits to report the time. Two Color Digits are used to represent hours, two for minutes, and two for seconds.

In addition to the six horizontally-arranged Color Digits, the panel can contain unit separators. The most common unit separators would be a colon between the hours and minutes Color Digits and a period between the minutes and seconds Color Digits. The unit separators may also be illuminated but preferably not in a color used by the Color Digits. The separators act as additional indicators of the clock's function and make it easier to read the time.

In another embodiment, the unit separators may be other symbols. These symbols make it harder to tell that the device is a clock, but still serve as a reference point for one who is aware they are looking at a clock and make it easier to read the time displayed by the Color Digits.

Both the separators and the Color Digits can be illuminated using red/green/blue light-emitting diodes. In one embodiment, the Color Digits and separators are surrounded by other unchanging light-emitting diodes.

The digital color clock can also include an alarm, temperature, humidity and optical sensors, atomic clock data radio receiver and an infrared receiver for remote control operation.

Replacing digits with colors can help persons with learning disabilities in reading digits tell time. It is also useful for those with vision problems, as in certain situations it is easier to differentiate between the Color Digits, than attempt to read actual numbers. A flicker or sparkle effect could be applied to certain colors (instead of using static colors for every digit) to make the device equally useful by the partially-colorblind.

In one embodiment learning the color code is fairly simple and can be accomplished by watching the repeating pattern of the Color Digits, specifically those related to seconds. In this instance, the same color code is used for each of the Color Digits.

The logic required by a user to deceiver the code and timing of the associated learning curves could be employed to measure the acuity and capabilities of the human brain, making the clock useful in Intelligence Quotient measurement or for evaluating mental health conditions.

To further aid in reading the clock, a color code decoding table or “cheat sheet” can scroll across on optional LCD screen. In one embodiment the cheat sheet could scroll the code, “Red=1, Blue=2, Green=3, . . . ”. In another embodiment, the cheat sheet could actually display the time in digital format, making it easier for the user to figure out the code.

The use of Color Digits in place of Arabic or Roman numerals is not limited to a physical clock. The Color Digits may also be used in a clock on a smartphone, computer, and the like. The color output could also be used as an alternative in other common numeric display devices such as calculators, alarm panels and multi-meters that measures current, voltage, resistance.

### BRIEF DESCRIPTION OF THE DRAWINGS

FIG. 1 is a front view of a the digital color clock which employs uniformly Color Digits to represent, from left to right, hours, minutes and seconds.

FIG. 2 is a front view of a digital color clock, employing uniquely shaped Color Digits to represent, from left to right, hours, minutes and seconds.

FIG. 3 is a front view of a digital color clock, which employs Color Digits to represent the time, humidity and temperature.

FIG. 4 is schematic diagram of the digital color clock showing its modules and constituent components.

### DETAILED DESCRIPTION OF PREFERRED EMBODIMENT(S)

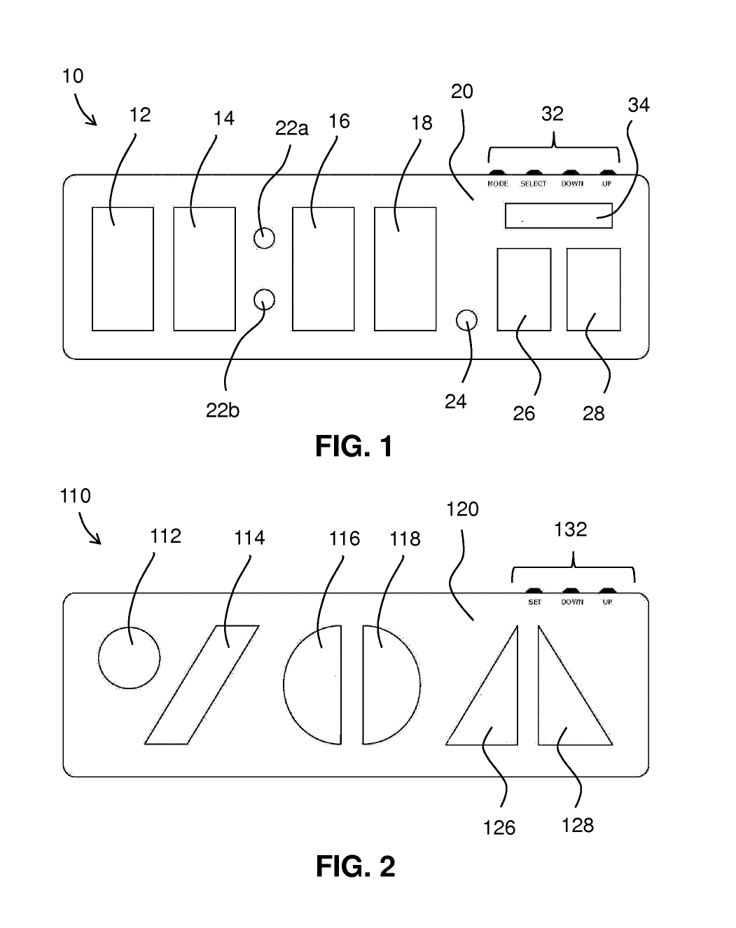

FIGS. 1, 2 and 3 illustrate various examples of a digital color clock.

FIG. 1 is a basic build of a digital color clock 10. Its main panel 20 includes six Color Digits for the tens digits of the hour 12, the ones digits of the hour 14, tens digits of the minute 16, the ones digits of the hour minute 18, tens digits of the second 26, and the ones of the second 28. The display uses a colon 22a, 22b and a period 24 for the unit separators.

The Color Digit for the tens digits of the hour 12 shows at least two different colors corresponding to 0 and 1. Likewise, the Color Digits for the tens digits of minute 16 and the tens digits of the second 26 show at least six different colors corresponding to 0-5. The rest of the Color Digits show all ten colors corresponding to 0-9.

The basic build includes an optional LCD panel 34 and a collection of buttons 32, which can be used to set the time or an alarm, among other functions.

FIG. 2 is digital color clock utilizing various shapes for the Color Digits 110. Its main panel 120 includes six Color Digits for the tens digits of the hour 112, the ones digits of the hour 114, tens digits of the minute 116, the ones digits of the hour minute 118, tens digits of the second 126, and the ones of the second 128. It does not contain a unit separator but does show the optional LCD panel 134 and a collection of buttons 132, which can be used to set the time or an alarm, among other functions.

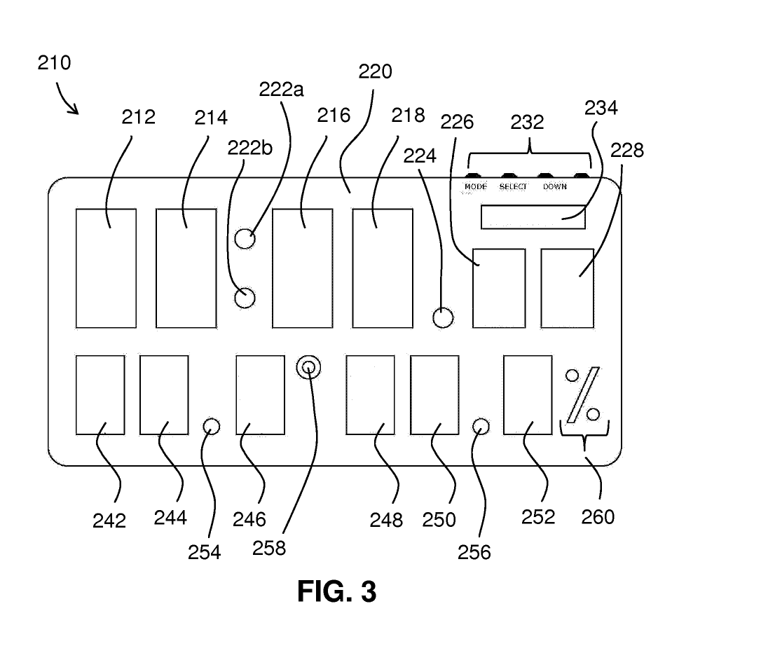

FIG. 3 is an advanced digital color clock 210 with a front panel 220 utilizing six Color Digits for the tens digits of the hour 212, the ones digits of the hour 214, tens digits of the minute 216, the ones digits of the hour minute 218, tens digits of the second 226, and the ones of the second 228.

The advance digital color clock 210 also contains three Color Digits for the temperature. One for the tens digit of the temperature 242, one for the ones digits of temperature 244, and one for the tenths digits of temperature 246.

The advance digital color clock 210 further contains three Color Digits for the humidity. One for the tens digits of the humidity 248, one for the ones digits of humidity 250, and one for the tenths digit of humidity 252.

In addition, FIG. 3 contains six unit separators: a colon 222a and 223b between the ones digits of the hour 214 and the tens digits of the minute 216; a period 224 between the ones digits of the minute 218 and the tens digits of the second 226; a period 254 between the ones digits of the temperature 244 and the tenths digits of the temperature 246; a degree sign 258 after the tenths digits of the temperature 246; a period 256 between the ones digits of the humidity 250 and the tenths digits of the humidity 252; and a percentage sign 260 after the tenths digits of the humidity 252.

Finally FIG. 3 illustrates an optional LCD panel 234 and a collection of buttons 232, which can be used to set the time or an alarm, among other functions.

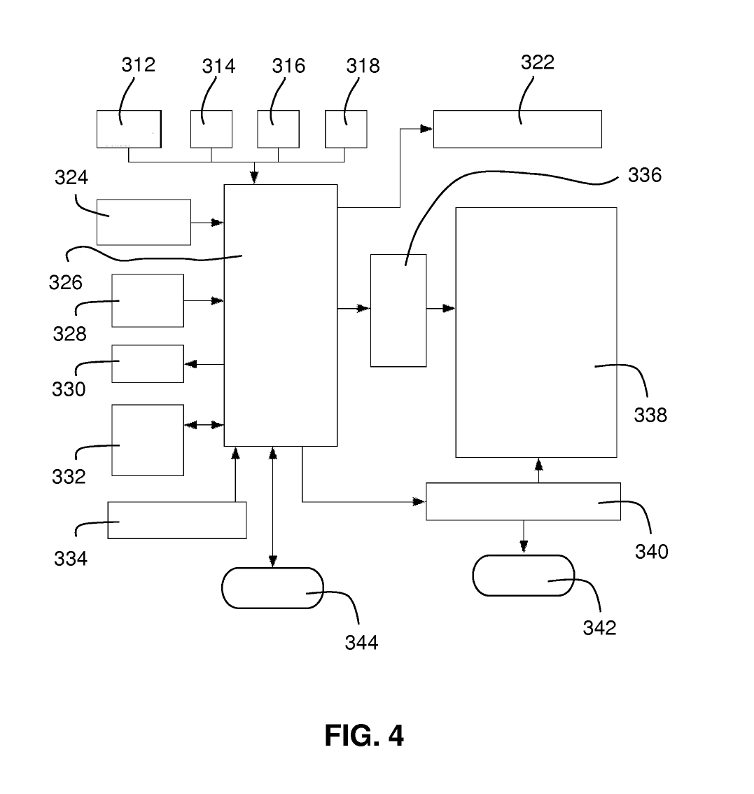

Turning to FIG. 4, an 8-bit microcontroller 326 running custom firmware code performs time-keeping functions, reading of buttons 334 for setting time and display modes, monitoring of ambient lighting conditions from a front light sensor 314 and a top or back light sensor 316 for automatic color and brightness adjustment, and other optional functions such as reading a temperature and/or humidity sensor 312, receiving information from a weather receiver 318 configured to receiver data from a remote weather station or displaying data on an optional LCD Panel 322. The microprocessor produces a multiplexed pulse-width-modulated output 336 for driving 40 RGB LEDs and 8 single-color LEDS 338, each capable of displaying 42-bit resolution (over 4 trillion colors). This robust color-depth capability allows the device to display its ten-digit colors over a large range of ambient lighting conditions. A 16-channel constant-current PWM LED driver 340, is used to adjust the LED color. Additional drivers 342, may be utilized to increase the numbers of LEDs being used, although this would decrease the number of shades that could be used by any single LED.

As an option, additional outputs for displaying other temporal information, such as year, month, day, temperature, barometric pressure and humidity can also be provided. Additional LED outputs can also support LEDs for display the colon symbol traditionally used to separate hours, minutes and seconds. Additional LEDs can also be used to illuminate the case or frame for the clock.

The clock can also act as a slave to another host processor 344. In this embodiment, the clock would merely display the numbers being calculated at the host processor 344. For example, the host processor might be running a program that counts down until a child's birthday. In this embodiment, the clock would display the digits being fed to it from the host processor as Color Digits.

Color and brightness uniformity of each digit's display window are important for correct, unambiguous identification of the 10 colors. Several techniques are employed to illuminate each digit's window evenly. Each RGB LED (which can be a “bank” of many individual red, green and blue LEDs) illuminates a window from the side or rear, tailored for high contrast and uniform light output and mixing of the individual red, green and blue LEDs.

For adequate contrast, ambient light should have a minimal effect on the LED windows. Typically, an anti-reflective, partially transparent film, as well as light-directing films should cover the clear plastic window to achieve high contrast and wide viewing angle.

These techniques are similar to those employed in edge-lit backlights for high-quality color liquid crystal display (LCD) panels employed in television and computer monitors.

The present digital color clock can adapt to the changing lighting conditions of the environment in which the device resides (to which the user's eyes also adjust with respect to brightness and white-balance), thus making the digits accurately readable in a wide range of ambient conditions. Two light sensors (typically digital RGB and ambient light sensors or simply phototransistors with color filters) can be incorporated to scale the brightness and hue of the 10 digit colors generated by the LEDs.

An algorithm in the microcontroller's firmware can slightly adjust the LED color code's overall hue to adjust for varying environmental white balance by integrating light sensor data. The algorithm can incorporate digital low-pass filters so these adjustments to brightness and hue occur with a similar speed as the human eye, making these changes transparent to the user.

To increases the clocks functionality, the clock can contain an infrared LED and receiver 332 for remote control use, an alarm amplifier and speaker 330, a microphone for automatic adjustment of alarm volume 328, a weather receiver configured to receiver data from a weather station 318, and/or an atomic clock data radio receiver 324.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A digital color clock for displaying time of day comprising:
(a) a housing comprising a front face;
(b) a controller capable of generating time-keeping signals comprising an hours signal, a minutes signal and a seconds signal; and
(c) a time display comprising six illuminated time panels located on said housing front face, a first of said time panels receiving said hours signal to display a color representing a tens digit in hours, a second of said time panels receiving said hours signal to display a color representing a ones digit in hours, a third of said time panels receiving said minutes signal to display a color representing a tens digit in minutes, a fourth of said time panels receiving said minutes signal to display a color representing a ones digit in minutes, a fifth of said time panels receiving said seconds signal to display a color representing a tens digit in seconds, a sixth of said time panels receiving said seconds signal to display a color representing a ones digit in seconds;
wherein said color representing said ones digit of said seconds in said sixth time panel is also employed as said color representing said ones digit of said minutes in said fourth time panel and as said color representing said ones digit of said hours in said second time panel, and wherein said color representing said tens digit of said seconds in said fifth time panel is also employed as said color representing said tens digit of said minutes in said third time panel and as said color representing said tens digit of said hours in said second time panel.

2. The digital color clock of claim 1, wherein each of said panels is illuminated by red/green/blue light-emitting diodes.

3. The digital color clock of claim 1, wherein each of said panels has a unique geometric shape.

4. The digital color clock of claim 1, wherein said front face has a plurality of colored sections and said panels are interspersed among said colored sections.

5. The digital color clock of claim 1, wherein said first and second panels are located adjacent one another to form an hours pair, said third and fourth panels are located adjacent one another to form a minutes pair, and said fifth and sixth panels are located one another to form a seconds pair, said housing front face further comprising:
(i) first separator indicia interposed between said hours pair and said minutes pair,
(ii) second separator indicia interposed between minutes pair and said seconds pair.

6. The digital color clock of claim 5, wherein said first and second separator indicia are illuminated.

7. The digital color clock of claim 5, wherein said first and second separator indicia are illuminated by red/green/blue light-emitting diodes.

8. The digital color clock of claim 5, wherein said first separator indicia is a colon and said second separator is a colon.

9. The digital color clock of claim 5, wherein said first separator indicia is a colon and said second separator indicia is a period.

10. The digital color clock of claim 1, further comprising:
(d) a controller capable of generating a temperature signal; and
(e) a temperature display comprising three illuminated temperature panels located on said housing front face, a first of said temperature panels receiving said temperature signal to display a color representing a hundreds digit in temperature, a second of said temperature panels receiving said temperature signal to display a color representing a tens digit in temperature, and a third of said temperature panels receiving said temperature signal to display a color representing a ones digit in temperature;
wherein said color representing said tens digit of said temperature panel is also employed as said color representing said tens digit of in said third and fifth time panels, and said color representing said ones digit of said temperature panel is also employed as said color representing said ones digit in said fourth and sixth time panels.

11. A method of displaying time of day comprising:
displaying at least three changeable color panels, each of said panels having a unique color corresponding to one of hour, minutes and seconds.

12. The method of claim 11, wherein said at least three changeable color panels comprises three pairs of panels, one of said pairs displaying a unique color corresponding to hour expressed in two digits, another of said pairs displaying a unique color corresponding to minutes expressed in two digits, and the remaining of said pairs displaying a unique color corresponding to seconds expressed in two digits.

13. The method of claim 11, further comprising forming said at least three changeable panels in the same geometric shape.

14. The method of claim 11, further comprising forming each of said at least three changeable panels in a unique geometric shape.

15. The method of claim 11, further comprising displaying a pair of symbols, one of said symbols interposed between said panel corresponding to hour and said panel corresponding to minutes, and the other of said symbols interposed between said panel corresponding to minutes and said panel corresponding to seconds.

16. The method of claim 11, further comprising interspersing each of said panels among other unchangeable color panels.

17. The method of claim 11, further comprising illuminating each of said panels using red/green/blue light-emitting diodes.

18. The method of claim 15, further comprising illuminating each of said symbols using red/green/blue light-emitting diodes.

19. A digital color clock comprising:
(a) a microcontroller, wherein said microcontroller performs a time-keeping function; and
(b) a panel containing six Color Digits, wherein said six Color Digits are configured to display one of ten colors, wherein said colors correspond to a number 0 through 9;
wherein said six Color Digits are further configured to display a time kept by the microcontroller by using said colors.

20. The digital color clock of claim 19, wherein said Color Digits have a same geometric shape.

21. The digital color clock of claim 19, wherein each of said Color Digits has a unique geometric shape.

22. The digital color clock of claim 19, further comprising:
(a) a first separator interposed between the first two of said six Color Digits corresponding to hours and the second two of said six Color Digits corresponding to minutes; and
(b) a second separator interposed between the second two of said six Color Digits corresponding to minutes and said last two of said six Color Digits corresponding to seconds.
